(19) United States
(12) Patent Application Publication
(10) Pub. No.: US 2005/0112537 A1
(43) Pub. Date: May 26, 2005

(54) Mobile teaching aid with audiovisual amusement device

(75) Inventor: Chih-Ming Wu, Taipei City (TW)

Correspondence Address: BRUCE H. TROXELL, SUITE 1404, 5205 LEESBURG PIKE, FALLS CHURCH, VA, 22041, US

(73) Assignee: Ladder Publishing Co., Ltd.

(21) Appl. No.: 10/716,490

(22) Filed: Nov. 20, 2003

(51) Int. Cl. G09B 5/00

(52) U.S. Cl. 434/310

(57) ABSTRACT

A mobile teaching aid with audiovisual amusement device is composed of a computer main unit, a projector, a keyboard, a mouse, a digital camera, a handwriting input device and a wireless net communication device (3G). The projector is mounted in the casing of the main unit to facilitate the user while in use. The digital camera and the handwriting input device are capable of helping the user to offer immediate teaching content and images so as to ease the teaching and have a sound surrounded ambience. The wireless net communication device (3G) is able to keep linking with the internet and receive uninterrupted net information.

### BACKGROUND OF THE INVENTION

1. Field of the Invention

The present invention relates to a teaching aid and particularly to a teaching aid with a function of audiovisual amusement additionally.

2. Description of Related Art

Conventionally, an optical type of projector is used for projecting transparent slides, which are prepared in advance or new for being written in new content instantly, as auxiliary content during a speaker engaging in a teaching, a speech or a briefing. However, the transparent slides are needed to replace whenever necessary and it is inconvenient that the transparent slides occupy more space.

Another way used is a portable computer associated with a projector while a teaching, a speech or a briefing is made. The explained content is saved in the portable computer in advance and then the stored content is projected to the screen sequentially along with the explanation of the speaker. It is advantageous that the projected pictures can be changed easily but it is disadvantageous that the portable computer is not possible to be added with new content for being projected to the screen during the teaching, the speech or the briefing.

Due to communication technology and internet technology being innovated incessantly, it makes the remote teaching and the video conference feasible. The preceding conventional teaching devices are not possible to keep pace with the demand of new teaching style so that there is a great improvement on the conventional teaching way.

### SUMMARY OF THE INVENTION

A primary object of the present invention is to provide a mobile teaching device, which is possible for an instructor to link the internet at any time for downloading teaching content and images promptly so as to ease the teaching and offer a sound surrounded ambience.

Another object of the present invention is to provide a mobile audiovisual teaching and amusement device, which combines multiple video and audio electric products as a single module, such that additional space occupied by the electric products and the additional cost for purchasing the electric products individually can be saved in spite of having functions of teaching aid and audiovisual amusement.

### BRIEF DESCRIPTION OF THE DRAWINGS

The present invention can be more fully understood by reference to the following description and accompanying drawing, in which:

FIG. 1 is a perspective view of a mobile teaching aid with audiovisual amusement device according to the present invention; and

FIG. 2 is a plan view illustrating a main unit of the present invention associated with a wireless net communication device.

### DETAILED DESCRIPTION OF THE PREFERRED EMBODIMENT

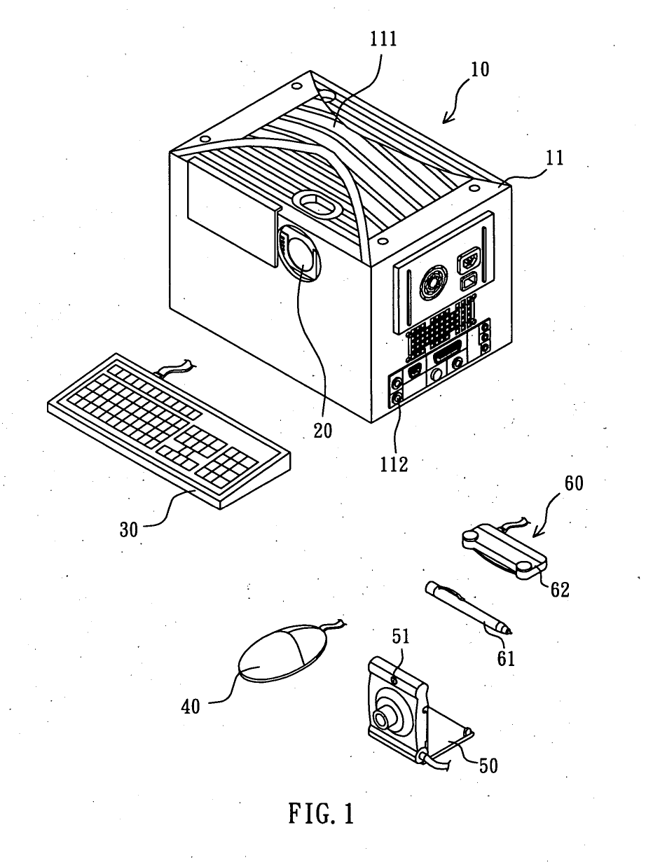

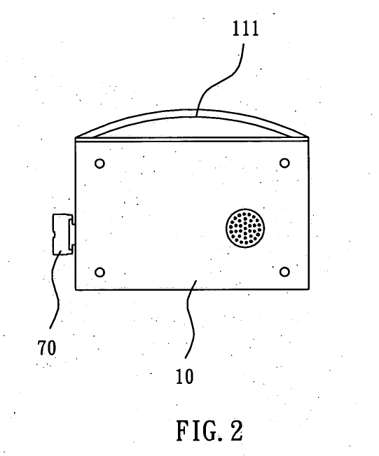

Referring to FIGS. 1 and 2, the mobile teaching aid with audiovisual amusement device according to the present invention is composed of a computer main unit 10, a projector 20, a keyboard 30, a mouse 40, a digital camera 50, a hand write input device 60 and a wireless net communication device 70.

The computer main unit 10 is provided with a casing 11 and the projector 20 is also disposed in the casing 11 in addition to a disk drive, a CD-ROM driver, speakers and a microphone, which are regularly equipped in a portable computer. The casing 11 has an opening corresponding to a projection lens of the projector 20 for the projector 20 being capable of projecting images via the opening.

The casing 11 at the top thereof is joined with a grip 111 for facilitating the user to carry the computer main unit 10 with him. In addition to having various required sockets for joining with interfaces as the portable computer does, the casing 11 further is provided with a cable TV receptacle 112 and an antenna of the wireless net communication device 70 as shown in FIG. 2. Alternatively, a conceal type of antenna can be used for the wireless net communication device 70.

The digital camera 50 has a light 51 for the lens being able to catch clearer images at darker areas and microscope lens can be used instead of the original lens for taking tiny pictures.

The handwriting input device 60 includes a hand writer 61 and a recognizer 62, which is available in the market. Further, Taiwan Publication No. 403877 discloses a handwriting input device, which has introduced more than one detection technique.

The computer main unit 10 is joined with the wireless net communication device 70 so that it is possible for the internet being linked to the computer main unit 10 via the wireless net communication device or for a hand set free telephone in company with the computer main unit 10 being dialed via the conventional wireless phone system. The wireless net communication device 70 can be linked to a wireless communication system device such, as GSM (Global System for Mobile comm.), GPRS (General Packet Radio Service), 3G (The third generation of mobile communications), CDMA (Code Division Multiple Access) or PHS (Personal Handy-phone System).

The keyboard 30, the mouse 40, the digital camera 50, the handwriting input device 60 and the conventional intranet or internet can be connected to the computer main unit 10 via wire transmission interfaces such as ordinary PS/2, USB, IEE1393 and IEE1394 or via wireless transmission way for transmitting signals to the computer main unit 10. The cable socket 112 of the computer main unit 10 can be connected to a cable for the TV so as to receive signals from the cable TV.

The computer main unit 10 is associated with the projector 20 inside the casing 11 instead of the conventional portable computer being required to connect an external projector such that it is not necessary to process the step of joining the projector and an action of taking projection can be performed right away conveniently.

The computer main unit 10 is associated with the digital camera 50 and the handwriting input device 60. The image taken by the digital camera 50 or the temporary data such as characters and drawings done by the user can be projected to a screen immediately via the projector 20 to facilitate the instructor making up new content. Especially, the digital camera 50 can be mounted a microscope lens instead to catch a micro image and display the micro image for enhancing the instructed content and the quality thereof. Further, the instructed data can be linked to the INTRANET and the INTERNET by utilizing the wire or wireless net communication device such the instructed instructive data can be transmitted to a far end computer to obtain an effect of far end prompt transmission for the audiovisual data.

The main unit 10 can receive signals from the cable TV and output the image data of the cable TV program or output video data stored in conventional VCD or DVD to the screen via the projector 20. Hence, once the main unit 10 is connected to internal or external speakers, one unit can provide audiovisual amusement functions involving a television, a video compact disk drive and a projector to save a space and cost for being occupied and purchasing multiple electric products with being used as teaching tool.

While the invention has been described with reference to a preferred embodiment thereof, it is to be understood that modifications or variations may be easily made without departing from the spirit of this invention, which is defined by the appended claims.

1. (canceled)

2. The mobile teaching aid with audiovisual amusement device according to claim 14, wherein the computer main unit is associated with connected to a digital camera.

3. (canceled)

4. The mobile teaching aid with audiovisual amusement device according to claim 14, wherein a wireless net communication device is connected to the computer main unit.

5. The mobile teaching aid with audiovisual amusement device according to claim 14, wherein the computer main unit and the handwriting input device are provided with a transmission interface respectively.

6. The mobile teaching aid with audiovisual amusement device according to claim 14, wherein a top of the casing has a handle.

7. The mobile teaching aid with audiovisual amusement device according to claim 2, wherein the computer main unit and the digital camera have a wireless transmission interface respectively.

8. The mobile teaching aid with audiovisual amusement device according to claim 2, wherein the digital camera is provided with a light.

9. The mobile teaching aid with audiovisual amusement device according to claim 2, wherein the digital camera has a microscope lens.

10. The mobile teaching aid with audiovisual amusement device according to claim 2, wherein a keyboard and a mouse are connected to the computer main unit.

11. The mobile teaching aid with audiovisual amusement device according to claim 2, wherein a wireless net communication device is connected to the computer main unit.

12. The mobile teaching aid with audiovisual amusement device according to claim 4, wherein the wireless net communication device is connected to a wireless communication system selected from the group of systems consisting of GSM, GPRS, 3G, CDMA a and PHS.

13. (canceled)

14. A mobile teaching aid with an audiovisual amusement device comprising:
a) a computer main unit having a casing;
b) a projector located in the casing and communicating with the computer main unit, the projector projecting an image through a casing hole in the casing;
c) a cable TV socket located on an exterior of the casing and connected to the computer main unit, the cable TV socket and the casing hole are located on different sides of the casing; and
d) a handwriting input device located outside the casing and communicating with the computer main unit.
